(19) United States
(12) Patent Application Publication
(10) Pub. No.: US 2003/0165423 A1
(43) Pub. Date: Sep. 4, 2003

(54) Direct synthesis of hydride compounds using a titanium aluminate dopant

(76) Inventors: Karl J. Gross, Fremont, CA (US); Eric H. Majzoub, Pleasanton, CA (US)

Correspondence Address: Timothy Evans, MS 9031, Sandia National Laboratories, 7011 East Avenue, Livermore, CA, 94550, US

(21) Appl. No.: 10/320,006

(22) Filed: Dec. 16, 2002

Related U.S. Application Data
(63) Continuation-in-part of application No. 10/066,375, filed on Jan. 29, 2002.

(51) Int. Cl. C01B 6/24

(52) U.S. Cl. 423/644; 423/648.1

(57) ABSTRACT

A method for directly preparing alkali metal aluminum hydrides such as NaAlH₄ and Na₃AlH₆ from either the alkali metal or its hydride, and aluminum. The hydride thus prepared is doped with a small portion of TiAl₃, in order to improve the reaction kinetics of the hydride compound thus formed. The process provides for mechanically mixing the dry reagents under an inert atmosphere followed by charging the mixed materials with high pressure hydrogen while heating the mixture to about 125° C.

### CROSS-REFERENCE TO RELATED APPLICATIONS

The following application for patent is a continuation-in-part of, and claims priority to, co-pending U.S. patent application Ser. No. 10/066,375, filed Jan. 29, 2002 and entitled “DIRECT SYNTHESIS OF CATALYZED HYDRIDE COMPOUNDS”

### STATEMENT OF GOVERNMENT INTEREST

This invention was made with Government support under government contract no. DE-AC04-94AL85000 awarded by the U.S. Department of Energy to Sandia Corporation. The Government has certain rights in the invention, including a paid-up license and the right, in limited circumstances, to require the owner of any patent issuing in this invention to license others on reasonable terms.

### BACKGROUND OF THE INVENTION

An embodiment of the invention relates to a method of producing a catalyzed alkali metal-aluminum hydride without also producing a hydride capacity robbing halide-salt. Another embodiment relates to a reversible hydrogen storage system utilizing the method for providing a catalyzed alkali metal-aluminum hydride without also producing a hydride capacity robbing halide-salt.

1. Technical Field

Alkali metals (lithium, sodium and potassium) form a wide variety of simple hydrides and complex intermetallic hydrides that are commonly used as reducing agents in various processes of organic chemistry. While simple alkali earth hydrides may be produced by direct reaction between molten alkali metal and hydrogen (at very high pressures and temperatures) preparation of the more complex hydrides of these metals has required development of specialized, individual processes.

2. Background Art

Hydrides of aluminum with lithium, sodium, and potassium have been known for many years. A direct synthesis method to produce these materials was first described (French Patent Serial Number 1,235,680). According to Ashby, synthesis of, for instance, NaAlH₄ can be performed by placing either the alkali metal or its hydride into an autoclave with activated aluminum powder in a solvent such as tetrahydrofuran. The mixture is subjected to hydrogen at a pressure of 2000 psi (about 135 atm) and heated to 150° C. for several hours after which the mixture is cooled, the excess aluminum is separated by filtration, and the NaAlH₄ isolated by precipitation using a hydrocarbon additive such as toluene to the tetrahydrofuran solution, followed by vacuum distillation of the tetrahydrofuran. The method is applicable to the production of LiAlH₄, NaAlH₄, KAlH₄ and CsAlH₄.

Others (Zakharin, et al., Dokl. Akad. Nauk SSR, vol. 1, No. 145, p. 793, 1962; Dvorak, et al. U.S. Pat. No. 3,357,806; Tranchant, et al. French Patent Serial Numbers 7,020,279 and 6,914,185) developed similar processes each of which relied on the use of an organic solvent.

While alkali-metal based complex hydrides were developed to serve as reducing agents in chemical reactions, other applications of these hydrides have also been considered in recent years. In particular, the development of hydrogen as an alternative to fossil fuels has spurred the search for materials capable of serving as economic sources for hydrogen storage and retrieval. Due to their gravimetric energy densities, hydrides of the alkali metals are very attractive. Most of these hydrides undergo decomposition releasing hydrogen at moderate temperatures (i.e., <150° C.).

However, the alkali metal hydrides prepared in the traditional manner act only to irreversibly release hydrogen under moderate conditions. While Bogdanovic, et al., (U.S. Pat. No. 6,106,801) have reported that the addition of a transition metal compound acts as a catalyst to aid in the re-absorption of hydrogen, the kinetics of this system have been reported to be slow and unstable. Zaluska, et al., (U.S. Pat. No. 6,251,349) have reported reversible absorption and desorption of hydrogen is achieved in complex alkali metal-aluminum hydride compounds prepared by mechanical mixing/milling mixtures of the simple hydrides without the catalyst reported by Bogdanovic, et al. However, most, if not all, of these prior art catalyzed processes also co-produce a halide-salt that degrades the overall capacity of the hydride system to store hydrogen.

### SUMMARY OF THE INVENTION

The present invention provides a new and different method for preparing a reversible titanium-doped alkali metal-aluminum hydride that avoids the problem of parasitic production of a halide salt. The process relies on using a titanium aluminate compound, in particular TiAl₃, instead of a titanium-halide compound in order to introduce the titanium into the hydride system.

In accordance with one aspect of the invention an alkali metal-aluminum hydride is prepared by mechanically milling a powder of a simple alkali metal hydride with aluminum metal powder and a TiAl₃ powder followed by high pressure hydrogenation at temperatures above about 60° C.

### BRIEF DESCRIPTION OF THE DRAWINGS

FIG. 1 shows an X-ray diffraction pattern of the NaAlH₄ hydride system prepared with TiCl₃ indicating the presence of the formation of TiAl₃.

FIG. 2 illustrates a first hydriding absorption cycle for the example of NaAlH₄ made by the process of the present invention with the starting of 1.0 M NaH+1.0 M Al+0.08 M TiAl₃.

FIG. 3 illustrates a first desorption cycle for the example of FIG. 2.

FIG. 4 shows Arrhenius plots of the rates of hydrogen desorption from the NaH sample that was doped with TiAl₃ using the direct synthesis method of the present invention to prepare NaAlH₄.

### DETAILED DESCRIPTION OF THE INVENTION

The hydrides of alkali metals and aluminum are compounds that belong to the larger class of complex hydrides. These compounds are known to liberate copious amounts of hydrogen either by direct thermal decomposition or by one-time hydrolysis. However, they were generally considered too irreversible for practical hydrogen storage applications until Bogdanovic, et al., (Bogdanovic and Schwickardi, J. Alloys and Compounds, vol. 253, no. 1, 1997) demonstrated that NaAlH₄, would reversibly desorb and absorbed hydrogen under relatively mild conditions when doped with one of a number of catalyst compounds. Since then there has been a growing body of work in characterizing catalyzed alkali metal-aluminum hydrides, as well as the development of new catalysts and methods of preparation.

A new embodiment for the preparation and production of a titanium-doped alkali metal-aluminum hydrides is provided. The method is believed to be applicable to the simple hydrides of alkali metals (Li, Na, and K), and of many of the alkaline earth (for example Mg, Ca, and Ba). The disclosed embodiment also avoids the problem of halide-salt production, associated with current methods for introducing titanium into alkali metal-aluminum hydride systems. A simple two step dry synthesis preparation process is provided that is generally similar to the process disclosed in prior co-pending U.S. patent application Ser. No. 10/066,375, herein incorporated by reference in its entirety. However, the present embodiment differs for the prior, co-pending method by introducing titanium into the hydride system by adding titanium aluminate (herein intended to mean “TiAl₃”), a reaction product of the prior method, as a starting material in synthesizing the hydride. In this way, the parasitic production of alkali halide-salts, generated by the prior processes through the reactions:

4NaH+4Al+TiCl₃ [symbol] NaAlH₄+3NaCl+TiAl₃

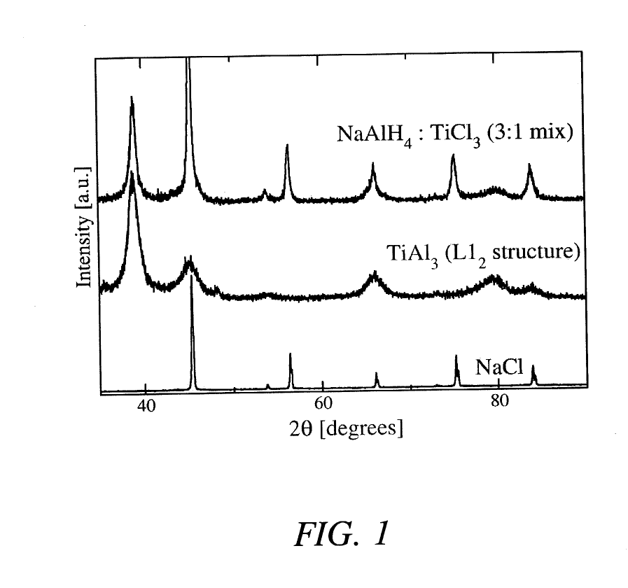

is eliminated and thus can improve the overall gravimetric hydrogen storage capacity of the synthesized hydride. In order to investigate the formation of TiAl₃ in the NaAlH₄ system, a mechanically milled 3:1 mixture of NaAlH₄ and TiCl₃ was prepared. FIG. 1, shows an x-ray diffraction pattern of the prepared NaAlH₄ hydride system indicating the formation of NaCl and TiAl₃ in the L1₂ structure, and is consistent with the above reaction.

General Method

In a first embodiment of the invention, a first step in the method used to produce the alkali metal-aluminum hydride comprises mixing desired proportion of powders of a simple alkali metal hydride (LiH, NaH, KH) with a titanium catalyst compound comprising TiAl₃, and an excess quantity of aluminum in a high energy ball mill in a dry and inert atmosphere of argon gas. (While not attempted, other dry gases such as helium, and hydrogen are also believed to be effective). The milling step is carried out at or near room temperature.

By way of example, the powders of the present invention are milled in a high energy ball mill such as are available from SPEX CertiPrep Inc., (203 Norcross Avenue, Metuchen, N.J. 08840). A SPEX™ 8000 series mixer/miller using 2 to 6, 10 mm diameter tungsten carbide (WC) balls and operated at a weight ratio of powder-to-balls of about 1:7 to about 1:9 was found to be suitable. A single batch of mixed powders comprised about 1.0 grams to about 10 grams of material per run.

The powders were milled for a total milling time of 2 hours, at near room temperature, and under a high purity argon gas atmosphere continuously gettered in order to control the available oxygen present in the atmosphere below of about 10 ppm O₂. After milling, about 1.5 grams of the mixture was transferred (again under an argon atmosphere) to a stainless steel reactor vessel with an internal volume of roughly 120 mL, and exposed to high purity (99.999%) hydrogen gas pressurized to between about 80 atm to about 100 atm while the steel reactor and its contents are heated externally with electrical tape to about 125° C. for up to 20 hours. Pressure measurements were taken using a calibrated 200 atm pressure transducer for the absorption half-cycle and a 1.3 atm calibrated Baratron™ capacitance manometer for the desorption half-cycle. Data was recorded with a computer.

The following example is provided below in order to better describe and illustrate this embodiment of the invention.

### EXAMPLE

In a first example, the hydride NaAlH₄ was produced by combining 2.74 grams of NaH with 3.08 grams of aluminum metal powder and 1.18 grams of a TiAl₃ catalyst precursor compound (molar ratios of 1:1:0.08) and then mechanically milling these powders in a tungsten-carbide lined steel vial with 6 tungsten-carbide balls in a SPEX™ mill (SPEX™ 8000) packed at a powder-to-ball weight ratio of about 1:7. The process was carried out at room temperature and under an argon atmosphere. The mixture of powders was milled for about 2 hours.

After milling the powders, approximately 2 grams of the mixture (under an argon atmosphere) was transferred to a stainless steel reactor vessel whose internal volume, measured to be about 119.2 ml, sealed, and pressurized with about 0.44 moles of high purity (>99.99%) hydrogen gas. The gas pressure within the reactor was increased from atmospheric ambient to between about 1340 psig after which the reactor was valved off and its contents heated to about 120° C., using an externally applied electrical heating strip. Heating was maintained at about 120° C. for about 50 hours after which the reactor temperature was decreased to room temperature. Pressure measurements were taken by using a calibrated 200 atm pressure transducer for the absorption half-cycle and a 1.3 atm calibrated Baratron™ capacitance manometer for the desorption half-cycle. Data was recorded with a computer. The reaction to produce the mixed alkali-metal aluminum hydride begins with the following constituents in the molar ratios shown:

$$NaH + Al + \frac{2}{25} {TiAl}_{3} + \frac{3}{2} {H}_{2}$$

As the reaction proceeds it is believed that the titanium aluminate interacts with the crystal structure of the sodium aluminate hydride but it is unclear in what manner. As previously mentioned, FIG. 1 appears to imply the presence of the titanium aluminate in the resultant reaction product but any proposed overall reaction is at best, speculative, such as for example:

$$NaH + Al + \frac{2}{25} {TiAl}_{3} + \frac{3}{2} {H}_{2} ⇔ \frac{1}{3} {Na}_{3} {AlH}_{6} + \frac{2}{3} Al + \frac{2}{25} {TiAl}_{3} + 2 {H}_{2}$$

$$and$$

$$\frac{1}{3} {Na}_{3} {AlH}_{6} + \frac{2}{3} Al + \frac{2}{25} {TiAl}_{3} + 2 {H}_{2} ⇔ {NaAlH}_{4} + \frac{2}{25} {TiAl}_{3}$$

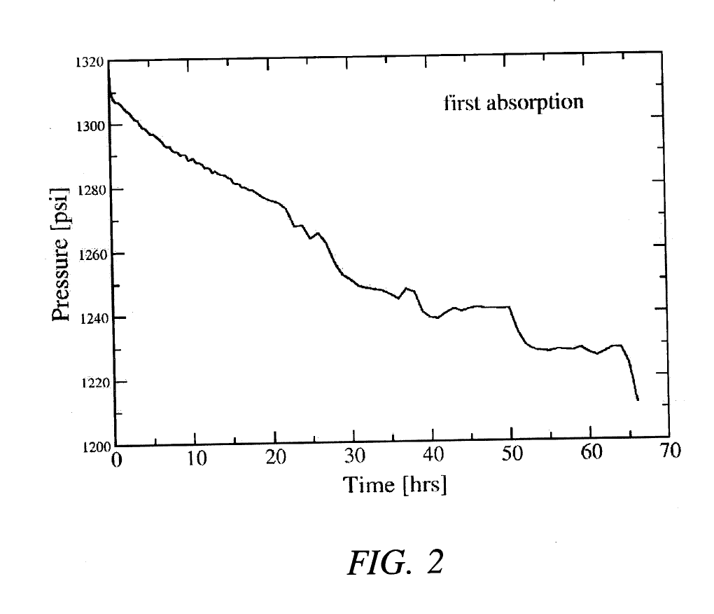

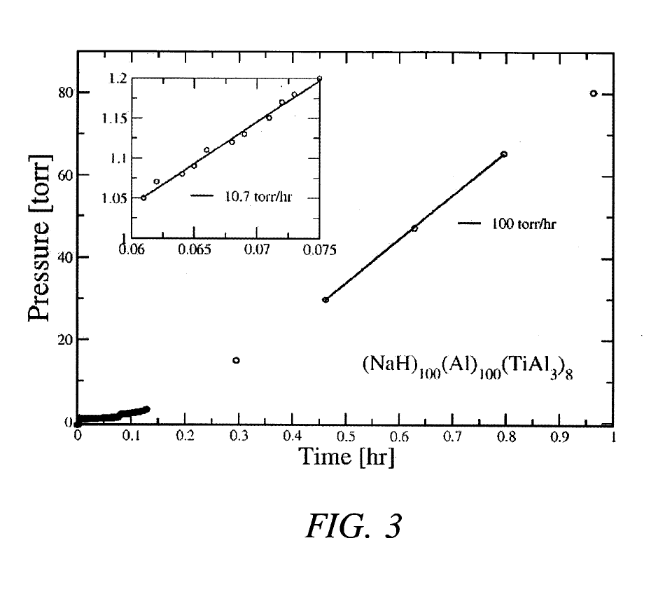

However, as shown in FIG. 2 (the 1^{st} absorption half-cycle)and FIG. 3 (the 1^{st} desorption half-cycle) the initial hydrogenation step in this Example provides evidence of an effect for this material. FIG. 2, shows the hydriding reaction progresses fairly smoothly for about the first 20 hours as the ambient pressure in the reaction vessel drops from about 1310 psig to about 1275 psi. Hydriding continued for about another 30 hours, although with somewhat erratic results, reaching a plateau at about 1242 psig between 42 and 50 hours. In all, the measure in the reactor pressure drop for this example was about 84 psi (1310 psig-1226 psig), equivalent to about 0.055 moles of monatomic hydrogen suggesting that about 0.012 moles or 0.63 grams of NaAlH4 was produced.

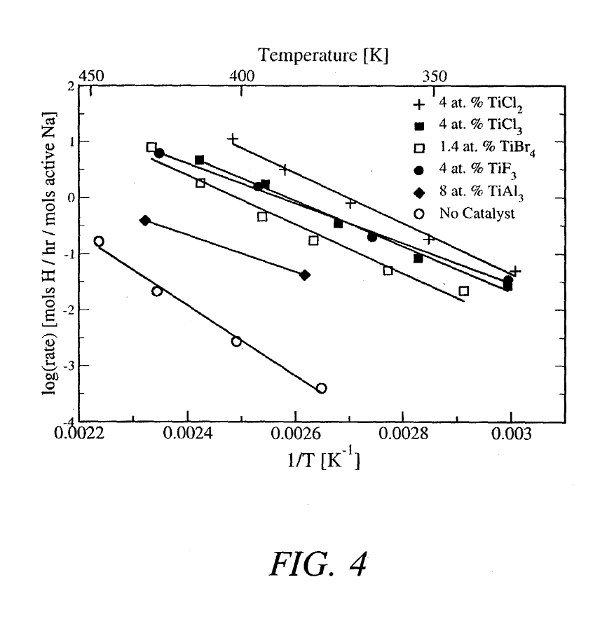

The foregoing example, therefore, demonstrates the formation of sodium aluminum hydride using a titanium aluminate as a vehicle for introducing titanium into the hydride system, i.e., without the use of a titanium halide catalyst. It is believed that lithium and potassium aluminum hydrides may be prepared using a similar technique. FIG. 4 illustrates the effect of the titanium aluminate on the reaction kinetics of the sodium aluminum hydride system and demonstrates an increase of just over an order of magnitude in the kinetics of hydrogen desorption by the TiAl₃ doped hydride material over the undoped material at about 120° C.

We claim:

1. A method of producing one or more complex hydride compounds capable of reversible hydrogenation, comprising:
mechanically mixing an alkali metal hydride with aluminum powder and a powdered form of TiAl₃ to provide a powder mixture; and
hydrogenating said powder mixture at an elevated temperature and pressure to provide an alkali metal-aluminum hydride compound.

2. The method according to claim 1, wherein said alkali metal hydride is selected from the group of hydrides consisting essentially of LiH, NaH, and KH.

3. The method according to claim 2, wherein the molar ratio of said alkali metal hydride to said aluminum powder is about 1:1 or greater.

4. The method according to claim 1, wherein said molar ratio of the TiAl₃ to the alkali metal hydride is greater then about 1:12.

5. The method according to claim 1, wherein said step of mechanically mixing comprises a process selected from the group consisting of ball milling, plate or impact grinding, and blending, stirring, or agitating with or without a mechanical aid.

6. The method according to claim 5, wherein said step of mechanically mixing comprises ball milling said powder mixture for between about 0.1 hours to about 10 hours.

7. The method according to claim 1, wherein said step of mechanically mixing is carried out in an atmosphere consisting essentially of argon.

8. The method according to claim 1, wherein said step of mechanically mixing is carried out at about room temperature.

9. The method according to claim 1, wherein said step of hydrogenation is performed at an initial temperature of above about 60° C., and wherein said hydrogen pressure is maintained above an equilibrium plateau pressure for hydrogen at said initial temperature.

11. The method according to claim 1, wherein said step of hydrogenation is performed at an initial temperature between about 120° C. and about 125° C., and wherein said hydrogen pressure is maintained at about 80 atmospheres to about 100 atmospheres for at least about 2 hours.

12. A method of producing one or more complex hydride compounds capable of reversible hydrogenation, comprising:
mechanically mixing a comminuted form of an alkali metal, with aluminum powder and a powdered form of TiAl₃ to provide a powder mixture; and
hydrogenating said powder mixture at an elevated temperature and pressure to provide an alkali metal-aluminum hydride compound.

13. The method according to claim 12, wherein said alkali metal is selected from the group consisting of Li, Na, and K.

14. The method according to claim 13, wherein the molar ratio of the alkali metal to the aluminum is about 1:1 or greater.

15. The method according to claim 12, wherein said molar ratio of the TiAl₃ to the alkali metal hydride is greater then about 1:12.

16. The method according to claim 12, wherein said step of mechanically mixing comprises a mechanical milling process selected from the group consisting of ball milling, plate or impact grinding, and blending, stirring, or agitating with or without a mechanical aid.

17. The method according to claim 12, wherein said step of mechanically mixing comprises ball milling said powder mixture for between about 0.5 hours to about 3 hours.

18. The method according to claim 12, wherein said step of mechanically mixing is carried out in an atmosphere consisting essentially of argon.

19. The method according to claim 12, wherein said step of mechanically mixing is carried out at about room temperature.

20. The method according to claim 12, wherein said step of hydrogenation is performed at an initial temperature above about 60° C., and wherein said hydrogen pressure is maintained above an equilibrium plateau pressure for hydrogen at said temperature.

21. The method according to claim 12, wherein said step of hydrogenation is performed at an initial temperature between about 120° C. and about 125° C., and wherein said hydrogen pressure is maintained at about 80 atmospheres to about 100 atmospheres for at least about 2 hours.

22. One or more complex alkali metal aluminum hydrides produced by the method of claim 1, wherein said one or more complex alkali metal aluminum hydrides exhibit reversible hydrogenated and dehydrogenation states.

23. A hydride according to claim 22, comprising NaAlH₄, or a mixture of Na₃AlH₆ and NaAlH₄.

24. A method of providing a source of hydrogen gas comprising:
heating a quantity of an alkali metal aluminum hydride or hydrides produced by the method of claim 12, to provide a supply of hydrogen gas and a dehydrogenated form of said alkali metal aluminum hydride; and
regenerating said alkali metal aluminum hydride by exposing said dehydrogenated form of said alkali metal aluminum hydride to a source of hydrogen gas and absorbing said hydrogen gas into said dehydrogenated form.

25. A method according to claim 24, wherein said alkali metal is selected from the group consisting of Li, Na, and K.
